(19) United States
(12) Patent Application Publication
(10) Pub. No.: US 2009/0227701 A1
(43) Pub. Date: Sep. 10, 2009

(54) WATER-SOLUBLE, RADIATION-CURABLE PRODUCTS AND USE THEREOF

(75) Inventors: Christian Krüger, Saulheim (DE); Bernd Bruchmann, Freinsheim (DE); Ulrike Hees, Mannheim (DE); Michael Kluge, Worms (DE); Cedric Dieleman, Scheibenhard (FR); Jürgen Weiser, Schriesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/573,498

(22) PCT Filed: Aug. 5, 2005
(86) PCT No.: PCT/EP05/08490

§ 371 Date: Feb. 9, 2007

(30) Foreign Application Priority Data
Aug. 19, 2004 (DE) 102004040419.4

(51) Int. Cl. C08F 2/46

(52) U.S. Cl. 522/174

(57) ABSTRACT

Water soluble radiation curable products (A) obtainable by mixing
mixing with or without reaction of
at least one hyperbranched polyurethane (a) with
at least one photoinitiator (b)
or by synthesis of
at least one hyperbranched polyurethane (a)
in the presence of at least one photoinitiator (b),
   are used to produce aqueous inks for the ink jet process.

The present invention relates to the use of water soluble radiation curable products (A) obtainable by mixing with or without reaction of

at least one hyperbranched polyurethane (a) with
at least one photoinitiator (b)
or by synthesis of
at least one hyperbranched polyurethane (a)
in the presence of at least one photoinitiator (b)
to produce aqueous inks for the ink jet process.

The present invention further relates to aqueous inks for the ink jet process having a dynamic viscosity in the range from 2 to 80 mPa·s, measured at 23° C., comprising (A) at least one water soluble radiation curable product obtainable by

mixing with or without reaction of
at least one hyperbranched polyurethane (a) with
at least one photoinitiator (b)
or by synthesis of
at least one hyperbranched polyurethane (a)
in the presence of at least one photoinitiator (b)
and also
(B) at least one pigment.

The present invention further relates to processes for producing ink jet inks, to processes for printing sheetlike substrates by the ink jet process and to printed sheetlike substrates.

Recording fluids and especially inks used in the ink jet process (such as Thermal Ink Jet, Piezo Ink Jet, Continuous Ink Jet, Valve Jet, transfer printing processes) have to meet a whole series of requirements: They have to have a viscosity and surface tension suitable for printing, they have to be stable in storage, i.e., they should not coagulate or flocculate, and they must not lead to clogging of the printer nozzle, which can be problematical especially in the case of inks comprising dispersed, i.e., undissolved, colorant particles. Stability in storage further requires of these recording fluids and especially inks that dispersed colorant particles do not sediment. Furthermore, in the case of Continuous Ink Jet the inks shall be stable to the addition of conducting salts and be free from any tendency to flock out with an increase in the ion content. In addition, the prints obtained have to meet colorists' requirements, i.e., show high brilliance and depth of shade, and have good fastnesses, examples being rub fastness, light fastness, water fastness and wet rub fastness, if appropriate after aftertreatment such as fixation for example, and good drying characteristics.

To ensure particularly good fastnesses such as rub fastness, wet rub fastness and wash fastness for example for printed substrates, the prints can be fixed by radiation curing. Radiation curable inks can be used for this, see for example U.S. Pat. No. 5,623,001 and EP 0 993 495. Radiation curable ink jet inks typically comprise a material which can be cured by application of actinic radiation. In addition, a photoinitiator can be included in radiation curable ink jet inks.

There is a problem, however, in that in some cases the degree of radiation curing is not uniform across the printed substrate. Curing is observed to be very good in some places, whereas it is poor in other areas, known as soft spots. Nonuniform curing compromises rub fastnesses in some areas. In addition, the hand of printed substrates deteriorates, which is undesirable for printed textile substrates in particular. There is thus a need for ink jet process inks which provide particularly uniform curing.

The present invention has for its object to provide ink jet process inks which undergo particularly effective curing upon application of actinic radiation. The present invention further has for its object to provide radiation curable products which are particularly useful for producing inks for the ink jet process. The present invention further has for its object to provide processes for producing inks for the ink jet process. The present invention finally has for its object to provide printed substrates and especially printed textile substrates having a particularly good hand and good fastnesses.

We have found that this object is achieved by the use of water soluble radiation curable products (A) which is defined at the beginning and the inks for the ink jet process which are defined at the beginning.

As used herein, the expressions “inks for the ink jet process”, “ink jet process inks” and “ink jet inks” are equivalent.

The use according to the present invention utilizes such water soluble radiation curable products (A) as are obtainable

by mixing with or without reaction of
at least one hyperbranched polyurethane (a) with
at least one photoinitiator (b)
or by synthesis of
at least one hyperbranched polyurethane (a)
in the presence of at least one photoinitiator (b)

In what follows, mixing with or without reaction of

at least one hyperbranched polyurethane (a) with
at least one photoinitiator (b)
will also be referred to as way 1.

Synthesis of

at least one hyperbranched polyurethane (a)
in the presence of at least one photoinitiator (b)
will hereinafter also be referred to as way 2.

Hyperbranched polyurethanes (a) shall for the purposes of the present invention be understood as meaning not just such polymers as are exclusively linked by urethane groups but in a more general sense polymers obtainable by reaction of di- or polyisocyanates with compounds comprising active hydrogen atoms. Polyurethanes for the purposes of the present invention thus may comprise urea, allophanate, biuret, carbodiimide, amide, ester, ether, uretoneimine, uretdione, isocyanurate or oxazolidine groups as well as urethane groups. As a general reference there may be cited by way of example: Kunststoffhandbuch/Saechtling, 26th edition, Carl-Hanser-Verlag, Munich 1995, pages 491 et seq. More particularly, polyurethanes for the purposes of the present invention comprise urea groups.

Hyperbranched polyurethanes (a) are molecularly and structurally nonunitary. This molecular nonunitariness distinguishes them from dendrimers and they are appreciably less costly to prepare.

Hyperbranched polyurethanes (a) are preferably prepared from ABₓ monomers, i.e., monomers comprising for example not only isocyanate groups and also groups capable of reacting with isocyanate groups to form a link and naturally also a spacer through which the isocyanate groups and groups capable of reacting with isocyanate groups to form a link are linked. x is a natural number from 2 to 8. x is preferably 2 or 3. Either A comprises isocyanate groups and B isocyanate-reactive groups, or vice versa.

Isocyanate-reactive groups preferably comprise OH, NH₂, NH, SH or COOH groups.

The synthesis of the hyperbranched polyurethanes (a) used in the present invention can be carried out for example as described hereinbelow.

ABₓ monomers are preparable in a conventional manner by various techniques.

ABₓ monomers can be synthesized for example by the method disclosed in WO 97/02304 using protective group techniques. This technique may be illustrated by way of example with regard to the preparation of an AB₂ monomer from 2,4-tolylene diisocyanate (TDI) and trimethylolpropane. First, one of the isocyanate groups of the TDI is capped in a conventional manner, for example by reaction with an oxime. The remaining free NCO group is reacted with trimethylolpropane, one of the three OH groups reacting with the isocyanate group. Detachment of the protective group leaves an AB₂ monomer having one isocyanate group and two OH groups.

The ABₓ monomers can be synthesized with particular advantage by the method disclosed in DE-A 199 04 444, for which no protective groups are required. In this method, di- or polyisocyanates are reacted with compounds having at least two isocyanate-reactive groups. At least one of the reactants has groups which differ in reactivity with regard to the other reactant. Preferably, both the reactants have groups which differ in reactivity with regard to the other reactant. The reaction conditions are chosen so that only specific reactive groups are able to react with each other.

Preferred di- and/or polyisocyanates having NCO groups with different reactivities are, in particular, readily and cheaply available isocyanates, examples being aromatic isocyanates such as 2,4-tolylene diisocyanate (2,4-TDI), 2,4′-diphenylmethane diisocyanate (2,4′-MDI), triisocyanatotoluene, or aliphatic isocyanates, such as isophorone diisocyanate (IPDI), 2-butyl-2-ethylpentamethylene diisocyanate, 2-isocyanatopropylcyclohexyl isocyanate, 2,4,4- or 2,2,4-trimethylhexamethylene diisocyanate, 2,4′-methylenebis(cyclohexyl)diisocyanate and 4-methylcyclohexane 1,3-diisocyanate (H-TDI).

Further examples of isocyanates having groups of differing reactivity are 1,3-phenylene diisocyanate, 1,4-phenylene diisocyanate, 1,5-naphthylene diisocyanate, biphenyl diisocyanate, toluidine diisocyanate and 2,6-tolylene diisocyanate. Addition of an NCO-reactive group onto one of the two initially equally reactive NCO groups serves to reduce the reactivity of the 2nd NCO group through electronic effects.

It will be appreciated that mixtures of the aforementioned isocyanates can be used as well.

Useful compounds having two or more isocyanate-reactive groups preferably include di-, tri- or tetrafunctional compounds whose functional groups differ in their reactivity toward NCO groups. Preference is given to compounds having at least one primary and at least one secondary hydroxyl group, at least one hydroxyl group and at least one mercapto group, more preferably having at least one hydroxyl group and at least one amino group in the molecule, especially amino alcohols, amino diols and amino triols, since the isocyanate reactivity of an amino group is distinctly higher than that of a hydroxyl group.

Examples of compounds having at least two isocyanate-reactive groups of differing reactivity are propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol or tris(hydroxymethyl)aminomethane. Mixtures of the identified compounds can be used as well. It is further possible to use compounds such as for example trimethylolpropane or trimethylolethane. Addition of an NCO group onto one of the initially equally isocyanate-reactive OH groups serves to reduce the reactivity of the second and especially of the third isocyanate-reactive group through steric and electronic effects.

The preparation of an AB₂ monomer may be illustrated by way of example for the case of a diisocyanate being reacted with an amino diol. Initially, one mole of a diisocyanate is reacted with one mole of an amino diol, for example N,N-diethanolamine, at low temperatures, preferably in the range between −10 to +30° C. In this temperature range, the urethane-forming reaction is virtually completely suppressed, the NCO groups of the isocyanate reacting exclusively with the amino group of the amino diol. The AB₂ monomer formed has a free NCO group and also two free OH groups and can be used to synthesize a hyperbranched polyurethane (a).

By heating or catalyst addition, this AB₂ monomer can react intermolecularly to form a hyperbranched polyurethane. Useful catalysts for preparing hyperbranched polyurethanes include for example organic tin compounds such as tin diacetate, tin dioctoate, dibutyltin dilaurate or strongly basic amines such as diazabicyclooctane, diazabicyclononane, diazabicycloundecane, triethylamine, pentamethyldiethylene-triamine, tetramethyldiaminoethyl ether or preferably triethylenediamine or bis(N,N-dimethylaminoethyl)ether or else weakly basic amines such as imidazoles for example. It is also possible to use mixed catalysts composed of at least one organic tin compound and at least one strongly basic amine. The amount of catalyst used is preferably in the range from 0.01% to 10% by weight and preferably in the range from 0.05% to 5% by weight, based on isocyanate. The synthesis of hyperbranched polyurethane (a) is advantageously carried out without prior isolation of the AB₂ monomer in a further reaction step at elevated temperature, preferably in the range between 30 and 80° C. Using the identified AB₂ monomer having two OH groups and one NCO group produces a hyperbranched polymer which per molecule comprises one free NCO group and also a number of OH groups which is dependent on the degree of polymerization. The reaction can be carried on to high conversions, whereby very high molecular weight structures are obtained. The reaction is preferably discontinued upon attainment of the desired molecular weight by adding suitable monofunctional compounds or by adding one of the starting compounds for preparing the AB₂ monomer. Depending on the starting compound used to discontinue the reaction, either fully NCO-terminated or fully OH-terminated molecules are produced.

In another embodiment, an AB₂ monomer may also be prepared for example from one mole of glycerol and 2 mol of TDI. At low temperature, it is primary alcohol groups and also the isocyanate group in position 4 which react preferentially, to form an adduct comprising one OH group and two isocyanate groups and which can be converted as described at higher temperatures to a hyperbranched polyurethane (a). The initial product will be a hyperbranched polyurethane (a) which comprises one free OH group and also an average number of NCO groups which is dependent on the degree of polymerization.

The number of NCO groups per molecule is from 2 to 100, preferably from 3 to 20 and more preferably up to 10.

The molecular weight Mₙ of the hyperbranched polyurethanes (a) to be used for the present invention may be for example in the range from 500 to not more than 50 000 g/mol, preferably not more than 15 000 g/mol and more preferably not more than 10 000 g/mol and most preferably up to 5000 g/mol.

The preparation of hyperbranched polyurethanes (a) can in principle be carried out without solvents, but is preferably carried out in solution. Useful solvents include in principle all compounds which are liquid, and inert toward the monomers and polymers, at the reaction temperature.

Other examples of hyperbranched polyurethanes (a) are obtainable by further versions of the synthesis. AB₃ monomers may be mentioned here by way of example. AB₃ monomers are obtainable for example by reaction of diisocyanates with compounds having 4 isocyanate-reactive groups. The reaction of tolylene diisocyanate with tris(hydroxymethyl)aminomethane may be mentioned by way of example.

To discontinue the preparation of hyperbranched polyurethanes (a), it is possible to use polyfunctional compounds capable of reacting with the respective A groups. This makes it possible to link a plurality of small hyperbranched molecules together to form one large hyperbranched molecule.

Hyperbranched polyurethanes (a) having chain-extended branches are obtainable for example by utilizing for the polymerization reaction not only ABₓ monomers but additionally, in a molar ratio of 1:1, a diisocyanate and a compound having two isocyanate-reactive groups. These additional AA and BB compounds may comprise further functional groups which, however, must not be reactive with A or B groups under the reaction conditions. Further functionalities may thereby be introduced into hyperbranched polyurethane (a).

Further versions of the synthesis of hyperbranched polyurethanes are to be found in WO 02/36695, DE-A 100 13 187 and DE-A 100 30 869.

Hyperbranched polyurethane (a) may be prepared using one or more catalysts. Useful catalysts include in principle all catalysts typically used in polyurethane chemistry.

Catalysts typically used in polyurethane chemistry include for example organic amines, especially tertiary aliphatic, cycloaliphatic or aromatic amines, and Lewis-acidic organic metal compounds.

Useful Lewis-acidic organic metal compounds include for example tin compounds, for example tin(II) salts of organic carboxylic acids, examples being tin(II) acetate, tin(II) octoate, tin(II) ethylhexanoate and tin(II) laurate and the dialkyltin(IV) derivatives of organic carboxylic acids, examples being dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate. Metal complexes such as acetylacetonates of iron, of titanium, of aluminum, of zirconium, of manganese, of nickel and of cobalt are possible as well. Further metal catalysts are described by Blank et al. in Progress in Organic Coatings, 1999, 35, 19 ff.

Preferred Lewis-acidic organic metal compounds are dimethyltin diacetate, dibutyltin dibutyrate, dibutyltin bis(2-ethylhexanoate), dibutyltin dilaurate, dioctyltin dilaurate, zirconium acetylacetonate and zirconium 2,2,6,6-tetramethyl-3,5-heptanedionate.

Similarly, bismuth and cobalt catalysts and also cesium salts can be used as hydrophobic catalysts. Useful cesium salts include cesium compounds utilizing the following anions: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻ and (Cₙ₊₁H₂ₙ₋₂O₄)²⁻, where n represents integers from 1 to 20.

Preference is given to cesium carboxylates in which the anion conforms to the formulae (CₙH₂ₙ₋₁O₂)⁻ and also (Cₙ₊₁H₂ₙ₋₂O₄)²⁻ where n is from 1 to 20. Particularly preferred cesium salts comprise monocarboxylates of the general formula (CₙH₂ₙ₋₁O₂)—, where n represents integers from 1 to 20, as anions. Formate, acetate, propionate, hexanoate and 2-ethylhexanoate must be mentioned in particular here.

As customary organic amines there may be mentioned by way of example: triethylamine, 1,4-diazabicyclo[2,2,2]octane, tributylamine, dimethylbenzylamine, N,N,N′,N′-tetramethylethylenediamine, N,N,N′,N′-tetramethylbutane-1,4-diamine, N,N,N′,N′-tetramethylhexane-1,6-diamine, dimethylcyclohexylamine, dimethyl-dodecylamine, pentamethyld ipropylenetriamine, pentamethyldiethylenetriamine, 3-methyl-6-dimethylamino-3-azapentol, dimethylaminopropylamine, 1,3-bisdimethyl-aminobutane, bis(2-dimethylaminoethyl)ether, N-ethylmorpholine, N-methyl-morpholine, N-cyclohexylmorpholine, 2-dimethylaminoethoxyethanol, dimethylethanol-amine, tetramethylhexamethylenediamine, dimethylamino-N-methylethanolamine, N-methylimidazole, N-formyl-N,N′-dimethylbutylenediamine, N-dimethylaminoethyl-morpholine, 3,3′-bisdimethylamino-di-n-propylamine and/or 2,2′-dipiparazine diisopropyl ether, dimethylpiparazine, tris(N,N-dimethylaminopropyl)-s-hexahydro-triazine, imidazoles such as 1,2-dimethylimidazole, 4-chloro-2,5-dimethyl-1-(N-methyl-aminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethyl-imidazole, 1-(3-aminopropyl)-2-ethyl-4-methylimidazole, 1-(3-aminopropyl)imidazole and/or 1-(3-aminopropyl)-2-methylimidazole.

Preferred organic amines are trialkylamines having independently two C₁- to C₄-alkyl radicals and one alkyl or cycloalkyl radical having 4 to 20 carbon atoms, for example dimethyl-C₄-C₁₅-alkylamine such as dimethyldodecylamine or dimethyl-C₃-C₈-cyclo-alkylamine. Likewise preferred organic amines are bicyclic amines which may if appropriate comprise a further heteroatom such as oxygen or nitrogen, an example being 1,4-diazabicyclo[2,2,2]octane.

It will be appreciated that mixtures of two or more of the aforementioned compounds may be used as catalysts as well.

Particular preference is given to using hydrophobic catalysts selected from the aforementioned compounds.

Catalysts are preferably used in an amount from 0.0001% to 10% by weight and more preferably in an amount from 0.001% to 5% by weight, based on the sum total of isocyanate and compound having isocyanate-reactive groups.

The catalyst or catalysts may be added in solid or liquid form or in solution, depending on the constitution of the catalyst or catalysts. Suitable solvents are water-immiscible solvents such as aromatic or aliphatic hydrocarbons such as for example toluene, ethyl acetate, hexane and cyclohexane and also carboxylic esters such as for example ethyl acetate. Preference is given to adding the catalyst or catalysts in solid or liquid form.

Hyperbranched polyurethanes (a) for the purposes of the present invention advantageously have on average, per molecule, at least one group which is ionizable in aqueous solution, or they are characterized through incorporation of nonionic hydrophilic end groups or moieties. As ionizable groups there may be mentioned by way of example COOH groups and SO₃H groups and also their alkali metal and ammonium salts and also quaternized amino groups. As nonionic hydrophilic end groups or moieties there may be mentioned by way of example:

—(OCH₂CH₂)_{z}OR⁶, where z is an integer in the range from 2 to 100 and preferably from to 50,
R⁶ represents C₁-C₄-alkyl, for example tert-butyl, sec-butyl, isobutyl, n-butyl, isopropyl, n-propyl, ethyl and especially methyl;
oligomeric and polymeric ethylene glycol of the formula HO—(CH₂CH₂O)_{z}H, where z is as defined above.

It is particularly advantageous to use hyperbranched polyurethanes (a) whose functional groups have been hydrophilicized or transfunctionalized. Particularly suitable hyperbranched polyurethanes (a) for producing water soluble radiation curable products (A) become available in this way for the use according to the present invention of hyperbranched polyurethanes (a) through the introduction of groups having affinity for pigment. Hyperbranched polyurethanes (a) having terminal NCO groups are particularly useful candidates for transfunctionalization because of their reactivity. It will be appreciated that OH— or NH₂-terminated polyurethanes can similarly be transfunctionalized by means of suitable reactants.

Examples of pigment affinity groups which are introduced by means of suitable reactants are —COOH, —COOR⁴, —CONHR⁴, —CONH₂, —OH, —SH, —NH₂, —NHR⁴, —N(R⁴)₂, —SO₃H, —SO₃R⁴, —N(phthalimide), —NHCOOR⁴, —NHCONH₂, —NHCONHR⁴ or —CN. The R⁴ radicals of the aforementioned groups are branched or unbranched alkyl radicals, are aralkyl radicals or are aryl radicals, which may be further substituted, examples being C₁-C₄₀-alkyl radicals and C₆-C₁₄-aryl radicals. The following radicals may be mentioned by way of example:

C₁-C₄₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl or n-eicosyl, particular preference being given to methyl;
C₆-C₁₄-aryl, for example phenyl, α-naphthyl, β-naphthyl, 1-anthracenyl, 2-anthracenyl or 9-anthracenyl,
C₇-C₁₃-aralkyl, preferably C₇- to C₁₂-phenylalkyl such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, more preferably benzyl.

Groups having sufficiently acidic H atoms can be converted into the corresponding salts by treatment with bases. Useful bases include for example hydroxides and bicarbonates of alkali metals or alkaline earth metals or the carbonates of alkali metals.

Useful bases further include volatile amines, i.e., amines having a boiling point of up to 180° C. at atmospheric pressure, examples being ammonia, methylamine, dimethylamine, trimethylamine, ethylamine, diethylamine, triethylamine, ethanolamine or N-methyldiethanolamine. Similarly, basic groups can be converted with acids such as for example α-hydroxy carboxylic acids or α-amino acids or else α-hydroxy sulfonic acids into the corresponding salts. Particularly useful hyperbranched polyurethanes (a) can be obtained as a result.

Acid groups can be introduced into hyperbranched polyurethanes (a), for example, by reaction with hydroxy carboxylic acids, mercapto carboxylic acids, hydroxy sulfonic acids or amino acids. Examples of suitable reactants include hydroxyacetic acid, hydroxypivalic acid, 4-hydroxybenzoic acid, 12-hydroxydodecanoic acid, 2-hydroxyethanesulfonic acid, mercaptoacetic acid, dimethylolpropionic acid, dimethylolbutyric acid, glycine, β-alanine or taurine.

In one embodiment of the present invention, hyperbranched polyurethane (a) may be prepared in the presence of up to 10 mol %, based on (a), of compounds having just one isocyanate-reactive group, examples being monoalcohols, primary or secondary monoamines or mercaptans.

In a preferred embodiment of the present invention, at least one hyperbranched polyurethane (a) is a hyperbranched polyurethane (a) having at least one NCO group per molecule (number average), preferably having at least 2 NCO groups per molecule (number average).

In a preferred embodiment of the present invention, water soluble radiation curable products (A) are water soluble radiation curable products (A) having at least one COOH group per molecule (number average). Preferably, at least water soluble radiation curable products (A) comprise a water soluble radiation curable product (A) where the COOH group is introduced by adding hydroxyacetic acid and more preferably β-alanine toward the end or after the synthesis of hyperbranched polyurethane (a), especially after expiration of a certain time. The reaction of the hydroxyl group of hydroxyacetic acid or especially of the amino group of β-alanine with an NCO group makes it possible to introduce COOH groups into particularly useful water soluble radiation curable products (A).

Preference is given to water soluble radiation curable products (A) having COOH groups situated at the end of a branch of the particular hyperbranched polyurethane (a).

“Per molecule” when used in the present invention in relation to a reaction of (a) with (b) which has not gone to completion, if it has proceeded at all, is to be understood as meaning per molecule of hyperbranched polyurethane (a) used.

The use according to the present invention can be effected according to way 1 by mixing with or without reaction of at least one hyperbranched polyurethane (a) with at least one photoinitiator (b).

The reaction of hyperbranched polyurethane (a) with photoinitiator (b) that may occur in the course of the mixing may proceed quantitatively (based on photoinitiator) or else not go to completion.

The mixing of (a) and (b) may be carried out in any desired vessels. One or more organic solvents and/or water can be added for the purpose of mixing. Suitable methods are stirring, shaking, but also dispersing in dispersing apparatuses such as for example ball mills and especially stirred media mills or shaking apparatuses, for example from Skandex.

In one embodiment of the present invention, (a) and (b) are mixed in a weight ratio in the range from 3:1 to 10 000:1, preferably in the range from 5:1 to 5 000:1 and most preferably in a weight ratio in the range from 10:1 to 1000:1.

Radiation curable product (A) according to the present invention may comprise a mixture of photoinitiator (b) with hyperbranched polyurethane (a). Similarly, photoinitiator (b) may also be covalently attached to hyperbranched polyurethane (a). If photoinitiator is to be covalently linked to hyperbranched polyurethane (a), then the quantitative ratios of hyperbranched polyurethane (a) and of photoinitiator (b) are each based on starting material, i.e., on hyperbranched polyurethane (a) and photoinitiator (b) prior to covalent linking.

A preferred embodiment of the present invention comprises adding photoinitiator (b) at the start or during the synthesis of hyperbranched polyurethane (a) (way 2) and thus synthesizing hyperbranched polyurethane (a) in the presence of at least one photoinitiator (b).

At least one photoinitiator (b) can be added at the start or during the above-described synthesis of hyperbranched polyurethane (a).

Any reaction of hyperbranched polyurethane (a) with photoinitiator (b) that may occur in the course of the mixing may proceed quantitatively (based on photoinitiator) or else not go to completion.

In one embodiment of the present invention, sufficient (b) is added during the synthesis of (a) that the weight ratio of (a) to (b) is in the range from 3:1 to 10 000:1, preferably in the range from 5:1 to 5000:1 and most preferably in the range from 10:1 to 1000:1, the assumption being that the formation of hyperbranched polyurethane (a) is quantitative.

(b) can be added in one or more portions.

One embodiment of the present invention comprises combining way 1 and way 2, i.e., for example, initially synthesizing hyperbranched polyurethane (a) in the presence of photoinitiator (b) and then mixing with a further photoinitiator (b), which is identical to or different from the photoinitiator present in the course of the synthesis of (a).

Suitable photoinitiators (b) include for example photoinitiators known to one skilled in the art, examples being those in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds), SITA Technology Ltd, London.

Useful photoinitiators include for example mono- or bisacylphosphine oxides as described in EP-A 0 007 508, EP-A 0 057 474, DE-A 196 18 720, EP-A 0 495 751 and EP-A 0 615 980, examples being 2,4,6-trimethylbenzoyidiphenylphosphine oxide, ethyl 2,4,6-trimethylbenzoylphenylphosphinate, bis(2,4,6-trimethylbenzoyl)phenylphosphine oxide, benzophenone, hydroxyacetophenone, phenylglyoxylic acid and derivatives thereof or mixtures of the aforementioned photoinitiators. As examples there may be mentioned benzophenone, acetophenone, acetonaphthoquinone, methyl ethyl ketone, valerophenone, hexanophenone, α-phenylbutyrophenone, p-morpholinopropio-phenone, dibenzosuberone, 4-morpholinobenzophenone, 4-morpholinodeoxybenzoin, p-diacetylbenzene, 4-aminobenzophenone, 4′-methoxyacetophenone, β-methylanthra-quinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetyl-benzene, thioxanthen-9-one, xanthen-9-one, 2,4-dimethylthioxanthone, 2,4-diethylthio-xanthone, 2,4-di-iso-propylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7-H-benzoin methyl ether, benz[de]anthracen-7-one, 1-naphthaldehyde, 4,4′-bis(dimethylamino)-benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-di-methylacetophenone, 2,2-dimethoxy-2-phenylacetophenone, 2,2-diethoxy-2-phenyl-acetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraq uinone, 2-amylanthraquinone and 2,3-butanedione.

Also suitable are nonyellowing or minimally yellowing photoinitiators of the phenylglyoxalic ester type, as described in DE-A 198 26 712, DE-A 199 13 353 or WO 98/33761.

Preferred photoinitiators (b) include for example photoinitiators which cleave upon activation, so called α-cleavage photoinitiators such as for example photoinitiators of the benzil dialkyl ketal type such as for example benzil dimethyl ketal. Further examples of useful α-cleavage photoinitiators are derivatives of benzoin, isobutyl benzoin ether, phosphine oxides, especially mono- and bisacylphosphine oxides, for example benzoyldiphenylphosphine oxide, 2,4,6-trimethylbenzoyldiphenylphosphine oxide, α-hydroxyalkylacetophenones such as for example 2-hydroxy-2-methylphenyl-propanone (b.1),

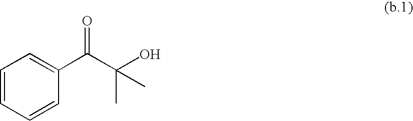

2-hydroxy-1-[4-(2-hydroxyethoxy)phenyl]-2-methyl-1-propanone (b.2)

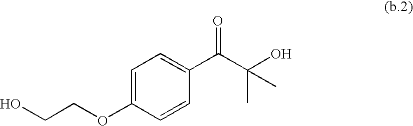

phosphine sulfides and ethyl 4-dimethylaminobenzoate and also

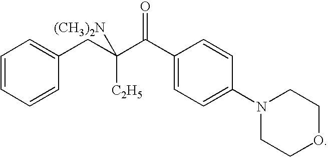

Preferred photoinitiators (b) further include for example hydrogen abstracting photoinitiators, for example of the type of the optionally substituted acetophenones, anthraquinones, thioxanthones, benzoic esters or of the optionally substituted benzophenones. Particularly preferred examples are isopropylthioxanthone, benzophenone, phenyl benzyl ketone, 4-methylbenzophenone, halomethylated benzophenones, anthrone, Michler's ketone (4,4′-bis-N,N-dimethyl-aminobenzophenone), 4-chlorobenzophenone, 4,4′-dichlorobenzophenone, anthraquinone.

To achieve covalent linking between photoinitiator (b) and hyperbranched polyurethane (a) it is preferable to choose such photoinitiators as comprise at least one group having an acidic hydrogen atom, for example compounds comprising at least one free OH group or at least one free NH₂ group. Particularly useful examples are 2-hydroxy-2-methylphenylpropanone (b.1) and 2-hydroxy-1-[4-(2-hydroxyethoxy)-phenyl]-2-methyl-1-propanone (b.2).

The efficacy of photoinitiators (b) in the present invention's radiation curable products (A) or the present invention's inks for the ink jet process can if desired be enhanced by the addition of at least one synergist, for example of at least one amine, especially of at least one tertiary amine. Useful amines include for example triethylamine, N,N-dimethylethanolamine, N-methylethanolamine, triethanolamine, amino acrylates such as for example amine-modified polyether acrylates. When amines such as for example tertiary amines have been used as a catalyst in the synthesis of hyperbranched polyurethane (a) and have not been removed after synthesis, it is also possible for tertiary amine used as a catalyst to act as a synergist. Furthermore, tertiary amine used to neutralize acidic groups such as for example COOH groups or SO₃H groups can act as a synergist. Up to twice the molar amount of synergist can be added, based on photoinitiator (b) used.

The present invention's water soluble radiation curable products (A) can have added to them at least one radical scavenger, for example sterically hindered amines such as for example HALS or stabilized nitroxyl free radicals such as 4-hydroxy-TEMPO (formula III)

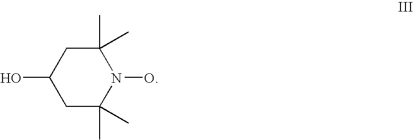

It may be preferable to add up to 1% by weight, based on (a) of radical scavengers, more preferably up to 0.5% by weight.

Water soluble radiation curable products (A) according to the present invention are curable by actinic radiation, for example actinic radiation having a wavelength range from 200 nm to 450 nm. Actinic radiation having an energy in the range from 70 mJ/cm² to 2000 mJ/cm² is suitable for example. Actinic radiation may preferably be applied continuously or in the form of flashes for example.

Radiation curable products (A) of the present invention are particularly useful for producing inks for the ink jet process, especially aqueous inks for the ink jet process. Radiation curable products (A) according to the present invention are very useful for producing pigmented aqueous inks for the ink jet process.

Herein, inks for the ink jet process are also referred to as ink jet inks or just as inks.

The present invention further provides inks for the ink jet process, especially aqueous inks for the ink jet process, comprising

(A) at least one water soluble radiation curable product obtainable by
mixing with or without reaction of
at least one hyperbranched polyurethane (a) with
at least one photoinitiator (b)
or by synthesis of
at least one hyperbranched polyurethane (a)
in the presence of at least one photoinitiator (b),
   (B) at least one pigment.

Hyperbranched polyurethanes (a) and photoinitiators (b) are described above.

The present invention's aqueous inks for the ink jet process further comprise at least one pigment (B). Pigments (B) for the purposes of the present invention are virtually insoluble, dispersed, finely divided, organic or inorganic colorants as per the definition in German standard specification DIN 55944. The process of the present invention preferably utilizes organic pigments, which comprises carbon black. Examples of particularly useful pigments will now be identified.

### Organic Pigments:

| | |
|---|---|
| Monoazo | C.I. Pigment Brown 25; C.I. Pigment Orange 5, 13, 36 |
| pigments: | and 67; C.I. Pigment Red 1, 2, 3, 5, 8, 9, 12, 17, 22, 23, |
| | 31, 48:1, 48:2, 48:3, 48:4, 49, 49:1, 52:1, 52:2, 53, 53:1, |
| | 53:3, 57:1, 63, 112, 146, 170, 184, 210, 245 and 251; |
| | C.I. Pigment Yellow 1, 3, 73, 74, 65, 97, 151 and 183; |
| Disazo | C.I. Pigment Orange 16, 34 and 44; C.I. Pigment Red |
| pigments: | 144, 166, 214 and 242; C.I. Pigment Yellow 12, 13, 14, |
| | 16, 17, 81, 83, 106, 113, 126, 127, 155, 174, 176 and |
| | 188; |
| Anthanthrone | C.I. Pigment Red 168 (C.I. Vat Orange 3); |
| pigments: | |
| Anthraquinone | C.I. Pigment Yellow 147 and 177; C.I. Pigment Violet |
| pigments: | 31; |
| Anthraquinone | C.I. Pigment Yellow 147 and 177; C.I. Pigment Violet |
| pigments: | 31; |
| Anthrapyri- | C.I. Pigment Yellow 108 (C.I. Vat Yellow 20); |
| midine | |
| pigments: | |
| Quinacridone | C.I. Pigment Red 122, 202 and 206; C.I. Pigment Violet |
| pigments: | 19; |
| Quinophtha- | C.I. Pigment Yellow 138; |
| lone | |
| pigments: | |
| Dioxazine | C.I. Pigment Violet 23 and 37; |
| pigments: | |
| Flavanthrone | C.I. Pigment Yellow 24 (C.I. Vat Yellow 1); |
| pigments: | |
| Indanthrone | C.I. Pigment Blue 60 (C.I. Vat Blue 4) and 64 (C.I. Vat |
| pigments: | Blue 6); |
| Isoindoline | C.I. Pigment Orange 69; C.I. Pigment Red 260; C.I. |
| pigments: | Pigment Yellow 139 and 185; |
| Isoindolinone | C.I. Pigment Orange 61; C.I. Pigment Red 257 and 260; |
| pigments: | C.I. Pigment Yellow 109, 110, 173 and 185; |
| Isoviolan- | C.I. Pigment Violet 31 (C.I. Vat Violet 1); |
| throne | |
| pigments: | |
| Metal complex | C.I. Pigment Yellow 117, 150 and 153; C.I. Pigment |
| pigments: | Green 8; |
| Perinone | C.I. Pigment Orange 43 (C.I. Vat Orange 7); C.I. |
| pigments: | Pigment Red 194 (C.I. Vat Red 15); |
| Perylene | C.I. Pigment Black 31 and 32; C.I. Pigment Red 123, |
| pigments: | 149, 178, 179 (C.I. Vat Red 23), 190 (C.I. Vat Red 29) |
| | and 224; C.I. Pigment Violet 29; |
| Phthalocya- | C.I. Pigment Blue 15, 15:1, 15:2, 15:3, 15:4, 15:6 and |
| nine | 16; C.I. Pigment Green 7 and 36; |
| pigments: | |
| Pyranthrone | C.I. Pigment Orange 51; C.I. Pigment Red 216 (C.I. Vat |
| pigments: | Orange 4); |
| Thioindigo | C.I. Pigment Red 88 and 181 (C.I. Vat Red 1); C.I. |
| pigments: | Pigment Violet 38 (C.I. Vat Violet 3); |
| Triarylcar- | C.I. Pigment Blue 1, 61 and 62; C.I. Pigment Green 1; |
| bonium | C.I. Pigment Red 81, 81:1 and 169; C.I. Pigment Violet |
| pigments: | 1, 2, 3 and 27; C.I. Pigment Black 1 (aniline black); |
| | C.I. Pigment Yellow 101 (aldazine yellow); C.I. Pigment |
| | Brown 22. |

### Inorganic Pigments:

| | |
|---|---|
| White pigments: | titanium dioxide (C.I. Pigment White 6), zinc white, pigmented |
| | zinc oxide; zinc sulfide, lithopones; lead white; |
| Black pigments: | iron oxide black (C.I. Pigment Black 11), iron-manganese black, spinell |
| | black (C.I. Pigment Black 27); carbon black (C.I. Pigment Black 7); |
| Color pigments: | chromium oxide, chromium oxide hydrate green; chromium green |
| | (C.I. Pigment Green 48); cobalt green (C.I. Pigment Green 50); |
| | ultramarine green, cobalt blue (C.I. Pigment Blue 28 and 36); |
| | ultramarine blue; iron blue (C.I. Pigment Blue 27); manganese |
| | blue; ultramarine violet; cobalt and manganese violet; iron oxide |
| | red (C.I. Pigment Red 101); cadmium sulfoselenide (C.I. Pigment |
| | Red 108); molybdate red (C.I. Pigment Red 104); ultramarine red; |

Iron oxide brown, mixed brown, spinell and corundum phases (C.I. Pigment Brown 24, 29 and 31), chromium orange;

Iron oxide yellow (C.I. Pigment Yellow 42); nickel titanium yellow (C.I. Pigment Yellow 53; C.I. Pigment Yellow 157 and 164); chromium titanium yellow; cadmium sulfide and cadmium zinc sulfide (C.I. Pigment Yellow 37 and 35); chromium yellow (C.I. Pigment Yellow 34), zinc yellow, alkaline earth metal chromates; Naples yellow; bismuth vanadate (C.I. Pigment Yellow 184);

| | |
|---|---|
| Interference | metallic effect pigments based on coated metal platelets; |
| pigments: | pearl luster pigments based on metal oxide coated mica |
| | platelets; liquid crystal pigments. |

Preferred pigments (B) in this context are monoazo pigments (especially laked BONS pigments, Naphthol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Examples of particularly preferred pigments (B) are specifically: carbon black, C.I. Pigment Yellow 138, C.I. Pigment Red 122 and 146, C.I. Pigment Violet 19, C.I. Pigment Blue 15:3 and 15:4, C.I. Pigment Black 7, C.I. Pigment Orange 5, 38 and 43 and C.I. Pigment Green 7.

Ink jet process inks according to the present invention are produced by mixing pigment (B) into radiation curable product of the present invention.

At the time at which pigment (B) is added, the radiation curable product (A) of the present invention preferably comprises less than 0.1% by weight of terminal NCO groups and more preferably no NCO groups, which are detectable by titration for example.

In a preferred embodiment of the present invention, ink jet process inks of the present invention comprise

(C) at least one photopolymerizable compound selected from compounds having at least two preferably terminal ethylenic double bonds per molecule and compounds of the general formula I

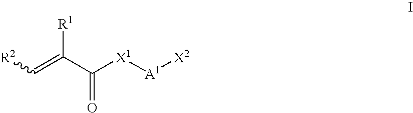

where
R¹ and R² are the same or different and are each independently selected from hydrogen and C₁-C₁₀-alkyl, branched or unbranched, such as for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; more preferably C₁-C₄-alkyl such as methyl, ethyl, n-propyl, isopropyl, n-butyl, isobutyl, sec-butyl and tert-butyl and most preferably methyl,
X¹ is selected from N—R³ and preferably oxygen,
A¹ is selected from C₁-C₂₀-alkylene which is unsubstituted or substituted by one or more of C₁-C₄-alkyl, phenyl or O—C₁-C₄-alkyl and in which one or more nonadjacent CH₂ groups may be replaced by oxygen;
A¹ may thus represent for example the following groups:
   —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₂—, —(CH₂)₁₄—, —(CH₂)₁₆—, —(CH₂)₁₈—, —(CH₂)₂₀—, preferably —(CH₂)ₐ—; —CH₂—CH(CH₃)—, —CH₂—CH(C₂H₅)—, —CH₂—CH(CH[CH₃]₂)—, —CH₂—CH(n-C₃H₇)—, —[CH(CH₃)]₂—, —CH(CH₃)—CH₂—CH₂—CH(CH₃)—, —CH(CH₃)—CH₂—CH(CH₃)—,
   —CH₂—C(CH₃)₂—CH₂—, —CH₂—CH(n-C₄H₉)—, —CH₂—CH (t-C₄H₉)—,
   —CH₂—O—, —CH₂—O—CH₂—, —(CH₂)₂—O—(CH₂)₂—, —[(CH₂)₂—O]₂—(CH₂)₂—, —[(CH₂)₂—O]₃—(CH₂)₂—,
   —COO—, —O—CO—, —CH₂—COO—, —CH₂—O—CO—, —(CH₂)₈—COO—, —(CH₂)ₙ—O—CO—, —COO(CH₂)ₐ—, —O—CO(CH₂)_{y}—,
   —(CH₂)_{y}—COO—(CH₂)_{y}—, —CH₂—O—CO—CH₂—, —CH(CH₃)—COO—CH₂—, —(CH₂)ₐ—O—CO—CH₂—, —CH₂—O—CO—(CH₂)ₐ—, —CH₂—COO—(CH₂)ₐ—, —COO—CH₂—COO—, —CH₂—COO—CH₂—COO—, —COO—(CH₂)ₐ—O—CO—, O—CO—(CH₂)ₙ—COO—, —COO—CH(CH₃)—,
   —O—C(O)—O—, —CH₂—O—C(O)—O—, —(CH₂)ₐ—O—C(O)—O—, —O—C(O)—O—(CH₂)ₐ—, —CH₂—O—C(O)—O—CH₂—, —(CH₂)ₐ—O—C(O)—O—CH₂—, —CH₂—O—C(O)—O—(CH₂)ₐ—,

### —CO—, —CH₂—CO—, —CO—CH₂—, —CH₂—CO—CH₂—, —CH(CH₃)—CO—CH₂—,

—CO—N(R³)—, —N(R³)—CO—, —(CH₂)_{y}—CO—N(R³)—, —(CH₂)_{y}—N(R³)—CO—, —(CH₂)_{y}—N(R³)—CO—(CH₂)_{y}—,
—N(R³)—CO—N(R³)—, —(CH₂)_{y}—N(R³)—CO—N(R³)—, —(CH₂)_{y}—N(R³)—CO—N(R³)—(CH₂)_{y}—, —(CH₂)_{y}—N(R³)—CO—N(R³)—(CH₂)_{y}—N(R³)—CO—N(R³)—,
y is in each occurrence the same or different and each time represents an integer in the range from 1 to 10, preferably from 2 to 8 and more preferably up to 6;
a is an integer in the range from 2 to 10, preferably from 2 to 6 and more preferably up to 4.

When an A¹ group carries plural R³ radicals, the R³ radicals may be the same or different.

Particularly preferred A¹ groups are

—CH₂—CH₂—O—, —(CH₂)₂—O—CO—O—, —(CH₂)₃—O—CO—O—, —(CH₂)₄—O—CO—O—, —(CH₂)₆—O—CO—O—, —NH—CH₂—NH—CO—, —NH—CH₂—NH—CO—(CH₂)₂—, —NH—CH₂—NH—CO—(CH₂)₃—, —NH—CH₂—NH—CO—(CH₂)₂—O—, —NH—CH₂—NH—CO—(CH₂)₃—O—, —NH—CH₂—NH—CO—(CH₂)₄—O—.
and

### —CH₂—CH₂—, —(CH₂)₃—, —(CH₂)₄—, —(CH₂)₅—, —(CH₂)₆—.

X² is selected from hydroxyl and NH—R³,
R³ is in each occurrence the same or different and selected from hydrogen, phenyl and C₁-C₁₀-alkyl, branched or unbranched, such as for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; more preferably C₁-C₄-alkyl such as methyl, ethyl, n-propyl, isopropyl, n-butyl, isobutyl, sec-butyl and tert-butyl
   and most preferably methyl.

Very particularly preferred compounds of the general formula I are 2-hydroxyethyl (meth)acrylate and 3-hydroxypropyl (meth)acrylate.

Particularly useful compounds having at least two terminal ethylenic double bonds per molecule are compounds of the general formula II

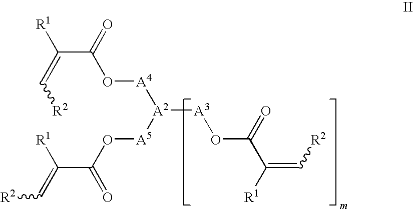

where
R¹ and R² are different or preferably the same and are each as defined above;
m is an integer from 0 to 2 and preferably 1;
A² is CH₂ or —CH₂—CH₂— or R⁵—CH or para-C₆H₄ when m is =0, CH, C—OH, C—O—C(O)—CH═CH₂, C—O—CO—C(CH₃)═CH₂, R⁵—C or 1,3,5-C₆H₃ when m is =1,
   and carbon when m=2;
R⁵ is selected from C₁-C₄-alkyl, such as for example n-C₄H₉, n-C₃H₇, iso-C₃H₇ and preferably C₂H₅ and CH₃,
   or phenyl,
A³, A⁴ and A⁵ are the same or different and are each selected from C₁-C₂₀-alkylene, such as for example —CH₂—, —CH(CH₃)—, —CH(C₂H₅)—, —CH(C₆H₅)—, —(CH₂)₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —CH(CH₃)—(CH₂)₂—CH(CH₃)—;
   cis- or trans-C₄-C₁₀-cycloalkylene, such as for example cis-1,3-cyclopentylidene, trans-1,3-cyclopentylidene cis-1,4-cyclohexylidene, trans-1,4-cyclohexylidene;
   C₁-C₂₀-alkylene, in each of which from one up to seven carbon atoms which are each nonadjacent are replaced by oxygen, such as for example —CH₂—O—CH₂—, —(CH₂)₂—O—CH₂—, —(CH₂)₂—O—CH₂)₂—, —[(CH₂)₂—O]₂—(CH₂)₂—, —[(CH₂)₂₋₀]₃—(CH₂)₂—;
   C₁-C₂₀-alkylene which is substituted by up to 4 hydroxyl groups, and in which from one up to seven carbon atoms which are each nonadjacent are replaced by oxygen, such as for example —CH₂—O—CH₂—CH(OH)—CH₂—, —CH₂—O—[CH₂—CH(OH)—CH₂]₂—, —CH₂—O—[CH₂—CH(OH)—CH₂]₃_{^{−}};
   C₆-C₁₄-arylene, such as for example para-C₆H₄.

Particularly preferred examples of compounds of the general formula II are trimethylolpropane triacrylate, triacrylate of triply ethoxylated trimethylolpropane, pentaerythritol tri(meth)acrylate and pentaerythritol tetra(meth)acrylate.

A further very useful representative of molecules having at least two terminal ethylenically unsaturated double bonds per molecule is ethylene glycol diacrylate.

Further very useful representatives of molecules having at least two terminal ethylenically unsaturated double bonds per molecule are partially or exhaustively (meth)acrylated polyols such as for example partially or exhaustively (meth)acrylated dimeric trimethylolpropane, partially or exhaustively (meth)acrylated dimeric trimethylolethane, partially or exhaustively (meth)acrylated dimeric pentaerythritol.

Photopolymerizable compound (C) can be freely present in the present invention's ink for the ink jet process, and then acts as a reactive diluent. But it is more preferable to react photopolymerizable compound (C), completely or incompletely, with hyperbranched polyurethane (a). The reacting can be hastened for example by heating or adding at least one catalyst, in which case the polyurethane chemistry catalysts described above are useful as catalysts.

In one embodiment of the present invention, inks according to the present invention comprise

from 1% to 20% by weight and preferably from 1.5% to 15% by weight of (A),
from 0.01% to 20% by weight and preferably from 1% to 10% by weight of (B),
from 0% to 10% by weight and preferably from 0.01% to 9% by weight of (C),
weight % ages all being based on the total weight of the present invention's ink in question.

Ink jet process inks of the present invention may further comprise at least one extra (D).

Ink jet process inks according to the present invention may comprise one or more organic solvents as extra (D). Low molecular weight polytetrahydrofuran (poly-THF) is a preferred extra (D), it can be used alone or preferably in admixture with one or more high boiling, water soluble or water miscible organic solvents.

The average molecular weight Mₙ of preferred low molecular weight polytetrahydrofuran is typically in the range from 150 to 500 g/mol, preferably in the range from 200 to 300 g/mol and more preferably about 250 g/mol (in keeping with a molecular weight distribution).

Polytetrahydrofuran is preparable in a known manner by cationic polymerization of tetrahydrofuran. The products are linear polytetramethylene glycols.

When polytetrahydrofuran is used as an extra (D) in admixture with further organic solvents, the further organic solvents employed will generally be high boiling (i.e., boiling point >100° C. at atmospheric pressure, in general) and hence water retaining organic solvents which are soluble in or miscible with water.

Useful solvents include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols including their lower polymers (di-, tri- and tetramers)) and their mono(especially C₁-C₆ and especially C₁-C₄)alkyl ethers. Preference is given to polyethylene and polypropylene glycols having average molecular weights in the range from 100 to 1500 g/mol, especially in the range from 200 to 800 g/mol and in particular in the range from 300 to 500 g/mol. As examples there may be mentioned diethylene glycol, triethylene glycol and tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ethers.

Useful solvents further include pyrrolidone and N-alkylpyrrolidones whose alkyl chain preferably comprises from 1 to 4 and in particular 1 or 2 carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (Mₙ 300 to 500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran can also be mixed with one or more (for example two, three or four) of the solvents recited above.

In one embodiment of the present invention, ink jet process inks according to the present invention may comprise from 0.1% to 80% by weight, preferably from 5% to 60% by weight, more preferably from 10% to 50% by weight and most preferably from 10% to 30% by weight of nonaqueous solvents.

Nonaqueous solvents used as extras (D), including in particular the identified particularly preferred solvent combinations, may advantageously be supplemented with urea (generally in the range from 0.5% to 3% by weight, based on the weight of the colorant preparation) to further enhance the water retaining effect of the solvent mixture.

Ink jet process inks according to the present invention may comprise further extras (D) of the kind which are customary especially for aqueous ink jet inks and in the printing and coatings industries. Examples include preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degassers/defoamers such as for example acetylenediols and ethoxylated acetylenediols, which typically comprise from 20 to 40 mol of ethylene oxide per mole of acetylenediol and may also have a dispersing effect, viscosity regulators, flow agents, wetters (for example wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyethersiloxane copolymers, especially alkoxylated 2-(3-hydroxypropyl)heptamethyltrisiloxanes, which generally comprise a block of 7 to 20 and preferably 7 to 12 ethylene oxide units and a block of 2 to 20 and preferably 2 to 10 propylene oxide units and may be comprised in the colorant preparations in amounts from 0.05% to 1% by weight), anti-settlers, luster improvers, glidants, adhesion improvers, anti-skinning agents, delusterants, emulsifiers, stabilizers, hydrophobicizers, light control additives, hand improvers, antistats, bases such as for example triethanolamine or acids, specifically carboxylic acids such as for example lactic acid or citric acid to regulate the pH. When these agents are a constituent part of the ink jet process inks according to the present invention, their total amount will generally be 2% by weight and especially 1% by weight, based on the weight of the present invention's colorant preparations and especially of the present invention's inks for the ink jet process.

Useful extras (D) further include alkoxylated or nonalkoxylated acetylenediols, for example of the general formula IV

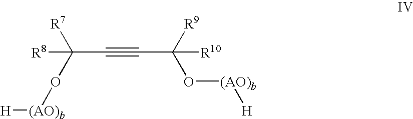

where
AO represents identical or different alkylene oxide units, for example propylene oxide units, butylene oxide units and especially ethylene oxide units,
R⁷, R⁸, R⁹ and R¹⁰ are each the same or different and selected from C₁-C₁₀-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, more preferably C₁-C₄-alkyl such as methyl, ethyl, n-propyl, isopropyl, n-butyl, isobutyl, sec-butyl and tert-butyl; and hydrogen;
b is in each occurrence the same or different and selected from integers in the range from 0 to 50, preferably 0 or 1 to 30 and more preferably 3 to 20;
AO is as defined above.

In a preferred embodiment of the present invention, R⁹ or R⁷ are methyl.

In a preferred embodiment of the present invention, R⁹ and R⁷ are methyl and R⁸ and R¹⁰ are isobutyl.

Other preferred extras are alkoxylated or nonalkoxylated silicon compounds of the formula V

[(CH₃)₃Si—O]₂—Si(CH₃)—O(CH₂CH₂O)_{b}—H V

where b is as defined above.

Ink jet process inks according to the present invention may further comprise a further photoinitiator other than the photoinitiator (b) which, according to the present invention, is used in the preparation of the present invention's radiation curable product (A), but is selected from the photoinitiators identified above.

Ink jet process inks according to the present invention have a dynamic viscosity in the range from 2 to 80 mPa·s, preferably from 3 to 40 mPa·s, and more preferably up to 25 mPa·s, measured at 23° C. in accordance with German standard specification DIN 53018.

The surface tension of ink jet process inks according to the present invention is generally in the range from 24 to 70 mN/m and especially in the range from 25 to 60 mN/m, measured at 25° C. in accordance with German standard specification DIN 53993.

The pH of ink jet process inks according to the present invention is generally in the range from 5 to 10 and preferably in the range from 7 to 9.

Ink jet process inks according to the present invention have altogether advantageous performance characteristics, in particular good start of print performance and good sustained use performance (kogation) and also, especially in the particularly preferred solvent combinations used, good drying performance, and produce printed images of high quality, i.e., of high brilliance and depth of shade and also high dry rub, light, water and wet rub fastness. They are particularly useful for printing coated and plain paper and also textile substrates.

A further aspect of the present invention is a process for producing ink jet process inks according to the present invention. The present invention's process for producing inks for the ink jet process comprises mixing (A), (B), water and if appropriate (C) with one another, for example in one or more steps.

Useful mixing techniques include for example stirring and intensive shaking and also dispersing, for example in ball mills or stirred media mills.

One embodiment of the present invention utilizes one or more pigments (B) which are in particulate form, i.e., in the form of particles.

The present invention is preferably practiced by utilizing predispersed pigment (B); that is, prior to mixing with, inter alia, (A) and if appropriate (C), one or more pigments are predispersed in an apparatus with at least one additive, for example at least one solvent, for example water, C₁-C₄-alkanol, polyetherol, diethylene glycol, triethylene glycol, tetraethylene glycol, n-butyl acetate. It is further possible to add dispersing additives during the dispersing or predispersing operation. Useful dispersing additives include for example compounds as more particularly described hereinbelow. Useful additives further include biocides, for example 1,2-benzisothiazolin-3-one (“BIT”) (commercially available as Proxel® brands from Avecia Lim.) or its alkali metal salts; other suitable biocides are 2-methyl-2H-isothiazole-3 (“MIT”) and 5-chloro-2-methyl-2H-isothiazol-3-one (“CIT”).

Useful dispersing additives include for example sulfated and alkylated polyalkylene glycols. Useful dispersing additives further include naphthalenesulfonic acid-formaldehyde condensation products, which may be mixed with aliphatic long-chain carboxylic acids such as for example stearic acid or palmitic acid or anhydrides thereof. The dispersing additives disclosed in U.S. Pat. No. 4,218,218 and U.S. Pat. No. 5,186,846 are particularly useful.

Useful dispersing additives further include in particular multiply alkoxylated fatty alcohols, for example from 3- to 50-tuply ethoxylated unbranched C₁₀-C₂₀-alkanols.

Useful apparatuses for the dispersing or predispersing include for example ball mills, stirred media mills, ultrasonic apparatuses, high pressure homogenizers, Ultra-Turax stirrers and shaking apparatuses such as for example from Skandex.

The dispersing or predispersing time is suitably in the range from half an hour to 48 hours for example, although a longer period is conceivable as well. Preferably, the dispersing or predispersing time is in the range from 1 to 24 hours.

Pressure and temperature conditions at predispersal are generally not critical in that, for example, atmospheric pressure will be suitable. Suitable temperatures range for example from 10° C. to 100° C.

The order of addition when mixing (A), (B), if appropriate (C) and if appropriate (D) is as such not critical. It is accordingly possible, in one version of the present invention, first to synthesize a hyperbranched polyurethane (a) in the presence of photoinitiator (b) and thus prepare (A), then to disperse pigment (B) with (A) and (D) and thereafter dilute with a solvent such as water for example.

In another version of the present invention, (a) is synthesized in the presence of (b) to prepare (A), (C) is added, followed by dispersing with (B), diluting with water and optionally mixing with further (b), (C) and (D).

The weight ratio of pigment (B) to water can be chosen in wide limits and can be for example in the range from 1:100 to 1:2.

Customary grinding aids can be added in the course of the dispersing or predispersing.

The average diameter of pigment (B) after predispersing is typically in the range from 20 nm to 1.5 μm, preferably in the range from 60 to 200 nm, more preferably in the range from 60 to 150 nm and generally identifies the volume average in the context of the present invention.

When carbon black is to be used according to the present invention as pigment (B), the particle diameter will refer to the average diameter of the primary particles.

A further aspect of the present invention is a process for printing sheetlike or three-dimensional substrates by the ink jet process using at least one ink jet process ink according to the present invention, hereinafter also referred to as inventive printing process. To practice the inventive printing process, at least one ink jet ink according to the present invention is printed onto a substrate. A preferred version of the inventive printing process comprises printing at least one ink jet ink of the present invention onto a substrate and then treating with actinic radiation.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (Bubble or Thermal Jet process) to exert pressure on the ink system and so eject an ink droplet. These techniques are described in Text. Chem. Color, volume 19 (8), pages 23 to 29, 1987, and volume 21 (6), pages 27 to 32, 1989.

The inks of the present invention are particularly useful for the bubble jet process and for the process employing a piezoelectric crystal.

Useful substrate materials include:

cellulosic materials such as paper, board, card, wood and woodbase, which may each be lacquered or otherwise coated,
metallic materials such as foils, sheets or workpieces composed of aluminum, iron, copper, silver, gold, zinc or alloys thereof, which may each be lacquered or otherwise coated,
silicatic materials such as glass, porcelain and ceramic, which may each be coated,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin,
leather—both natural and artificial—in the form of smooth leather, nappa leather or suede leather,
comestibles and cosmetics,
and in particular
textile substrates such as fibers, yarns, threads, knits, wovens, nonwovens and garments composed of polyester, modified polyester, polyester blend fabric, cellulosic materials such as cotton, cotton blend fabric, jute, flax, hemp and ramie, viscose, wool, silk, polyamide, polyamide blend fabric, polyacrylonitrile, acetate, triacetate, polycarbonate, polypropylene, polyvinyl chloride, polyester microfibers and glass fiber fabric.

Useful actinic radiation includes electromagnetic radiation having a wavelength range from 200 nm to 450 nm. Actinic radiation having an energy in the range from 70 mJ/cm² to 2000 mJ/cm² is useful for example. Actinic radiation may advantageously be applied continuously or in the form of flashes for example.

In one embodiment of the present invention, after printing and before treatment with actinic radiation interdrying can be carried out, for example thermally or with IR radiation. Examples of suitable conditions are temperatures ranging from 30 to 120° C. for a period from 1 minute to 24 hours, preferably up to 30 min, more preferably up to 5 min. Useful IR radiation includes for example IR radiation in a wave region above 800 nm. Useful interdrying apparatuses include for example drying cabinets including vacuum drying cabinets for thermal interdrying, and also IR lamps.

Similarly, the heat involved upon application of actinic radiation can have an interdrying effect.

The present invention further provides substrates, especially textile substrates, which have been printed by one of the inventive printing processes identified above and which are notable for particularly crisply printed images or drawings and also excellent hand. Moreover, printed substrates according to the present invention have few if any soft spots.

In a further embodiment of the present invention, two or more and preferably three or more different ink jet process inks according to the present invention can be combined into sets, in which case different inks according to the present invention each comprise different pigments each having a different color.

The present invention further provides water soluble radiation curable products (A) obtainable by

mixing with or without reaction of
at least one hyperbranched polyurethane (a) with
from 0.001% to 10% by weight of at least one photoinitiator (b),
or by synthesis of
at least one hyperbranched polyurethane (a)
in the presence of from 0.001% to 10% by weight, preferably 0.01% to 5% by weight, of at least one photoinitiator (b).

All weight % ages are based on (a).

Hyperbranched polyurethane (a) and photoinitiators (b) are described above.

In a preferred embodiment of the present invention, at least one hyperbranched polyurethane (a) is a hyperbranched polyurethane (a) having at least one NCO group and preferably having at least two NCO groups per molecule (number average).

In another preferred embodiment of the present invention, the water soluble radiation curable product (A) is a water soluble radiation curable product (A) having at least one COOH group per molecule (number average).

In one embodiment of the present invention, at least one photoinitiator is an α-cleavage photoinitiator or a hydrogen abstracting photoinitiator.

In one embodiment of the present invention, water soluble radiation curable products (A) according to the present invention comprise as a further component (C) at least one photopolymerizable compound selected from compounds having at least two preferably terminal ethylenic double bonds per molecule and compounds of the general formula I

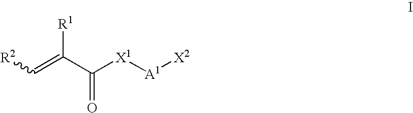

where
R¹ and R² are the same or different and are each independently selected from hydrogen and C₁-C₁₀-alkyl,
X¹ is selected from oxygen and N—R³,
A¹ is selected from C₁-C₂₀-alkylene which is unsubstituted or substituted by one or more of C₁-C₄-alkyl, phenyl or O—C₁-C₄-alkyl and in which one or more nonadjacent CH₂ groups may be replaced by oxygen;
X² is selected from hydroxyl and NH—R³,
R³ is in each occurrence the same or different and selected from hydrogen, C₁-C₁₀-alkyl and phenyl.

One embodiment of the present invention comprises choosing compounds having at least two preferably terminal ethylenic double bonds per molecule from compounds of the general formula II

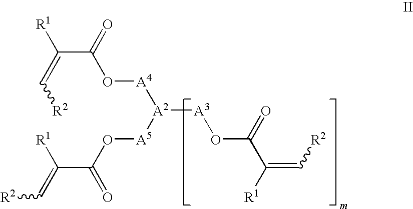

where
R¹ and R² are the same or different and are each independently selected from hydrogen and C₁-C₁₀-alkyl,
m is an integer from 0 to 2,
A² is CH₂ or —CH₂—CH₂— or R⁵—CH or para-C₆H₄ when m is ═O, CH, C—OH, C—O—C(O)—CH═CH₂, C—O—CO—C(CH₃)═CH₂, R⁵—C or 1,3,5-C₆H₃ when m is =1,
   and carbon when m is =2;
R⁵ is selected from C₁-C₄-alkyl and phenyl,
A³, A⁴ and A⁵ are the same or different and are each selected from
   C₁-C₂₀-alkylene, cis- or trans-C₄-C₁₀-cycloalkylene, C₁-C₂₀-alkylene, in each of which from one up to seven carbon atoms which are each nonadjacent may be replaced by oxygen,
   C₁-C₂₀-alkylene which is substituted by up to 4 hydroxyl groups and in which from one up to seven carbon atoms which are each nonadjacent may be replaced by oxygen, C₆-C₁₄-arylene.

Radiation curable products (A) according to the present invention are particularly useful for producing inks for the ink jet process.

The invention is illustrated by working examples.

### General Preliminaries:

The NCO content was in each case determined titrimetrically in accordance with German standard specification DIN 53185.

β-Alanine solution Al-1 was prepared as follows:

In a conical flask, 57.0 g of β-alanine were dissolved in 300 g of distilled water, 65.0 g of triethylamine and 120.0 g of acetone were added and the mixture was refluxed for one hour. Cooling down to room temperature gave β-alanine solution Al-1.

The average particle diameter of pigments was determined using a Coulter LS230 Coulter Counter from Coulter. Dynamic viscosities were always measured at 23° C. in accordance with German standard specification DIN 53018.

### I. Preparation of Inventive Radiation Curable Products

### I.1. Preparation of Inventive Radiation Curable Product A.1

A 2 l three neck flask equipped with stirrer, reflux condenser, gas inlet tube and dropping funnel was charged with 200 g (0.9 mol) of isophorone diisocyanate (IPDI) under nitrogen. A solution of 60 g (0.45 mol) of trimethylolpropane (TMP) and 16 g of 2-hydroxy-2-methylphenylpropanone (b.1)

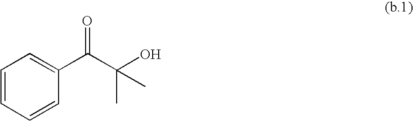

in 276 g of 2-butanone was added in the course of 1 min with stirring.

This was followed by the metered addition of 0.1 g of di-n-butyltin dilaurate before heating the resulting reaction mixture to 60° C. with stirring. The reduction in the NCO content was monitored titrimetrically. When the NCO content reached 5.5% by weight, 129 g (0.17 mol) of a polyisocyanurate based on hexamethylene diisocyanate, having an NCO content of 22.5% by weight and an average functionality of 3.7 NCO groups per molecule, dissolved in 129 g of 2-butanone, were added and the resulting reaction mixture was stirred at 60° C. for one hour. The NCO content of the resulting hyperbranched polyurethane (a.1) then was 6.6% by weight. This was followed by the addition of 31.0 g of 2-hydroxyethyl acrylate (C.1), stabilized with 100 ppm of 4-hydroxy-TEMPO (formula III), dissolved in 73 g of acetone, and thereafter 0.1 g of di-n-butyltin dilaurate and stirring of the resulting reaction mixture at 60° C. for three hours. 742 g of temperature-controlled β-alanine solution Al-1 at 60° C. were then added to the resulting reaction mixture.

This was followed by another 30 min of stirring at 60° C. Acetone and 2-butanone were subsequently distilled off in a rotary evaporator at 60° C. under reduced pressure (2 mbar) and the residue was taken up with distilled water to give a 30% by weight aqueous solution of inventive radiation curable product (A.1).

### I.2. Preparation of a Hyperbranched Polyurethane (a.2)

A 2 l three neck flask equipped with stirrer, reflux condenser, gas inlet tube and dropping funnel was charged with 200 g (0.9 mol) of isophorone diisocyanate (IPDI) under nitrogen. A solution of 60 g (0.45 mol) of trimethylolpropane (TMP) in 260 g of 2-butanone was added in the course of 1 min with stirring.

This was followed by the metered addition of 0.02 g of di-n-butyltin dilaurate before heating the resulting reaction mixture to 60° C. with stirring. The reduction in the NCO content was monitored. When the NCO content reached 5.5% by weight, 129 g (0.17 mol) of a polyisocyanurate based on hexamethylene diisocyanate, having an NCO content of 22.5% by weight and an average functionality of 3.7 NCO groups per molecule, dissolved in 129 g of 2-butanone, were added and the resulting reaction mixture was stirred at 60° C. for one hour. The NCO content of the resulting hyperbranched polyurethane (a.2) then was 6.3% by weight. This gave hyperbranched polyurethane (a.2) dissolved in 2-butanone.

### I.3. Preparation of Inventive Water Soluble Radiation Curable Product (A.2)

192 g of solution of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 4 g of 2-hydroxy-2-methylphenylpropanone (b.1), 16 g of 2-hydroxyethyl acrylate (C.1), stabilized with 100 ppm of 4-hydroxy-TEMPO (formula III), 0.02 g of di-n-butyltin dilaurate and 20 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then acetone and 2-butanone were distilled off in a rotary evaporator at 60° C. under reduced pressure (2 mbar) and the residue was taken up with distilled water to give a 20% by weight aqueous solution of the inventive water soluble radiation curable product (A.2).

### I.4. Preparation of Inventive Water Soluble Radiation Curable Product (A.3)

192 g of hyperbranched polyurethane (a.2) from I.2 were charged under nitrogen to a 2 l three neck flask equipped with stirrer, reflux condenser, gas inlet tube and dropping funnel. This was followed by metered addition, with stirring, of a mixture of 8 g of 2-hydroxy-2-methylphenylpropanone (b.1), 16 g of 2-hydroxyethyl acrylate (C.1), stabilized with 100 ppm of 4-hydroxy-TEMPO (formula III), 0.02 g of di-n-butyltin dilaurate and 24 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then acetone and 2-butanone were distilled off in a rotary evaporator at 60° C. under reduced pressure (2 mbar) and the residue was taken up with distilled water to give a 30% by weight aqueous solution of the inventive water soluble radiation curable product (A.3).

### I.5. Preparation of Inventive Radiation Curable Product (A.4)

192 g of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 4 g of 2-hydroxy-2-methylphenylpropanone (b.1), 4 g of ethyl 4-(N,N-dimethylamino)-benzoate (b.3), 16 g of 2-hydroxyethyl acrylate (C.1), stabilized with 100 ppm of 4-hydroxy-TEMPO (formula III), 0.02 g of di-n-butyltin dilaurate and 24 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then acetone and 2-butanone were distilled off in a rotary evaporator at 60° C. under reduced pressure (2 mbar) and the residue was taken up with distilled water to give a 30% by weight aqueous solution of the inventive water soluble radiation curable product (A.4).

### I.6. Preparation of Inventive Radiation Curable Product (A.5)

192 g of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 4 g of 2-hydroxy-2-methylphenylpropanone (b.1), 4 g of benzoyl phosphine oxide (b.4), 16 g of 2-hydroxyethyl acrylate (C.1), stabilized with 100 ppm of 4-hydroxy-TEMPO (formula III), 0.02 g of di-n-butyltin dilaurate and 24 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then acetone and 2-butanone were distilled off in a rotary evaporator at 60° C. under reduced pressure (2 mbar) and the residue was taken up with distilled water to give a 30% by weight aqueous solution of the inventive radiation curable product (A.5).

### I.7. Preparation of Inventive Radiation Curable Product (A.6)

192 g of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 2 g of 2-hydroxy-2-methylphenylpropanone (b.1), 2 g of benzoyl phosphine oxide (b.4), 16 g of 2-hydroxyethyl acrylate (C.1), stabilized with 100 ppm of 4-hydroxy-TEMPO (formula III), 0.02 g of di-n-butyltin dilaurate and 20 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then the solvents acetone and 2-butanone were distilled off in a rotary evaporator at 60° C. under reduced pressure (2 mbar) and the residue was taken up with distilled water to give a 30% by weight aqueous solution of the inventive water soluble radiation curable product (A.6).

### I.8. Preparation of Inventive Water Soluble Radiation Curable Product (A.7)

192 g of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 10.3 g of 2-hydroxy-2-methylphenylpropanone (b.1), 5.3 g of 2-hydroxyethyl acrylate (C.1), stabilized with 100 ppm of 4-hydroxy-TEMPO (formula III), 0.02 g of di-n-butyltin dilaurate and 15.6 g of acetone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then the solvents acetone and 2-butanone were removed in a rotary evaporator at 60° C. under reduced pressure (2 mbar) and the residue was taken up with distilled water to give a 30% by weight aqueous solution of the inventive water soluble radiation curable product (A.7).

### I.9. Preparation of Inventive Water Soluble Radiation Curable Product (A.8)

192 g of hyperbranched polyurethane (a.2) from 1.2 were charged under nitrogen to a 2 l three neck flask equipped with stirrer, reflux condenser, gas inlet tube and dropping funnel. This was followed by metered addition, with stirring, of a mixture of 4 g of phenyl benzyl ketone (b.5), 16 g of 2-hydroxyethyl acrylate (C.1), stabilized with 100 ppm of 4-hydroxy-TEMPO (formula III), 0.02 g of di-n-butyltin dilaurate and 20 g of 2-butanone. This was followed by heating to 60° C. and stirring at 60° C. for three hours. The reaction mixture was subsequently admixed with 156.2 g of temperature-controlled β-alanine solution Al-1 at 60° C.

The reaction mixture was subsequently stirred at 60° C. for 30 min. Then the solvent 2-butanone was removed in a rotary evaporator at 60° C. under reduced pressure (2 mbar) and the residue was taken up with distilled water to give a 30% by weight aqueous solution of the inventive water soluble radiation curable product (A.8).

### II. Use Examples

### II.1. Production of Pigment Grinds, General Prescription

Pigment grinds for organic pigments were produced on a Skandex using 60 g of glass balls 0.25-0.5 mm in diameter. The recipes are summarized in table 1. After the ingredients and the glass balls had been weighed into the Skandex, the resulting mixture was shaken for a period of time as indicated in table 1. Thereafter, a sample was taken and the average diameter of dispersed pigment determined (Coulter Counter). The pH was measured and—if necessary—adjusted to 7.5 with triethanolamine. Pigment grinds PA.1.1 to PA.1.3 were obtained.

TABLE 1
Ingredients and recipe parameters for
pigment grinds PA.1.1 to PA.1.3

| Ingredient | PA.1.1 | PA.1.2 | PA.1.3 |
|---|---|---|---|
| (B) as per C.I., [g] | P.R. 122, 6 | P.BK. 7, 6 | P.Y. 138, 6 |
| (A-1) [g] | 20 | 20 | 20 |
| Propylene glycol [g] | 3 | 3 | 3 |
| Biocide 1 [g] | 0.3 | 0.3 | 0.3 |
| Tri-n-butyl phosphate [g] | 0.05 | 0.05 | 0.05 |
| Distilled water [g] | 30.65 | 30.65 | 30.65 |
| Dispersing time [h] | 2 | 1 | 3 |
| Average diameter of | 67 | 120 | 145 |
| pigment [nm] | | | |

Amounts of ingredients are always reported in g unless expressly stated otherwise.

Biocide 1 is a 20% by weight solution of 1,2-benzisothiazolin-3-one in propylene glycol

Further pigment grinds were obtained by proceeding as described above but in each case replacing (A.1) by (A.2), (A.3) etc. The following pigment grinds were obtained:

PA.2.1 (magenta, using (A.2)),
PA.2.2 (black, using (A.2)),
PA.2.3 (yellow, using (A.2)),
PA.3.1 (magenta, using (A.3)),
PA.3.2 (black, using (A.3)),
PA.3.3 (yellow, using (A.3)),
PA.4.1 (magenta, using (A.4)),
PA.4.2 (black, using (A.4)),
PA.4.3 (yellow, using (A.4)),
PA.5.1 (magenta, using (A.5)),
PA.5.2 (black, using (A.5)),
PA.5.3 (yellow, using (A.5)),
PA.6.1 (magenta, using (A.6)),
PA.6.2 (black, using (A.6)),
PA.6.3 (yellow, using (A.6)),
PA.7.1 (magenta, using (A.7)),
PA.7.2 (black, using (A.7)),
PA.7.3 (yellow, using (A.7)),
PA.8.1 (magenta, using (A.8)),
PA.8.2 (black, using (A.8)),
PA.8.3 (yellow, using (A.8)).

### II.2 Formulation of Inventive Inks for Ink Jet Process

### II.2.1 Formulation of Inventive Magenta Ink T1.1 for Ink Jet Process

The following were mixed with one another by stirring in a glass beaker:

### 25 g of PA.1.1,

1 g of urea,
3 g of triethylene glycol mono-n-butyl ether,
6 g of poly-THF of average molecular weight Mₙ 250 g/mol
5 g of polyethylene glycol with Mₙ=400 g/mol,
6 g glycerol,
0.5 g of 20% by weight solution of 3-benzisothiazolinone in propylene glycol,
0.5 g of ethoxylated trisiloxane of the formula [(CH₃)₃Si—O]₂—Si(CH₃)—O(CH₂CH₂O)₈—H
53 g of distilled water.

The inventive ink T1.1 was obtained after filtering through a glass fiber filter (exclusion size 1 μm). The inventive ink T1.1 had a pH of 7.0 and a dynamic viscosity of 2.8 mPa·s.

### II.2.2 Formulation of Inventive Black Ink T1.2 for Ink Jet Process

The following were mixed with one another by stirring in a glass beaker:

### 35 g of PA.1.2,

1 g of urea,
3 g of triethylene glycol mono-n-butyl ether,
6 g of poly-THF of average molecular weight Mₙ 250 g/mol
5 g of polyethylene glycol with Mₙ=400 g/mol,
6 g glycerol,
0.5 g of 20% by weight solution of 3-benzisothiazolinone in propylene glycol,
0.5 g of ethoxylated trisiloxane of the formula [(CH₃)₃Si—O]₂—Si(CH₃)—O(CH₂CH₂O)₈—H
43 g of distilled water.

The inventive ink T1.2 was obtained. Inventive ink T1.2 had a pH of 7.86 and a dynamic viscosity of 3.6 mPa·s.

### II.2.3 Formulation of Inventive Yellow Ink T1.3 for Ink Jet Process

The following were mixed with one another by stirring in a glass beaker:

### 40 g of PA.1.3,

1 g of urea,
3 g of triethylene glycol mono-n-butyl ether,
6 g of poly-THF of average molecular weight Mₙ 250 g/mol
5 g of polyethylene glycol with Mₙ=400 g/mol,
6 g glycerol,
0.5 g of 20% by weight solution of 3-benzisothiazolinone in propylene glycol,
0.5 g of ethoxylated trisiloxane of the formula [(CH₃)₃Si—O]₂—Si(CH₃)—O(CH₂CH₂O)₈—H
38 g of distilled water.

The inventive ink T1.3 was obtained. Inventive ink T1.3 had a pH of 6.53 and a dynamic viscosity of 3.2 mPa·s.

### II.2.4 Production of Further Inventive Inks

The above procedure was repeated replacing PA.1.1, PA.1.2 and PA1.3 by respectively one of the grinds PA.2.1 to PA.8.3. In all cases, 25 g of magenta pigment grind were selected to produce magenta inks, 35 g of black pigment grinds to produce black inks and 40 g of yellow pigment grind to produce yellow inks, in each case with the appropriate amount of distilled water. Inventive inks T2.1 to T8.3 were obtained. The dynamic viscosities of inventive inks T2.1 to T8.3 ranged from 2.5 to 4.0 mPa·s.

III. Printing Trials with Inventive Inks for Ink Jet Process

The inventive inks were filled into cartridges and printed onto paper using an Epson 3000 720 dpi printer. Per 5 DIN A4 pages at most 5 nozzles failed. The rub fastness tests produced good values.

In addition, the inventive inks T1.1 to T1.3 were printed onto cofton using an Epson 3000 720 dpi printer. Printing was followed by drying in a drying cabinet at 100° C. for 5 minutes and treatment with actinic radiation using an IST UV irradiator comprising two different UV lamps: Eta Plus M-400-U2H, Eta Plus M-400-U2HC. Exposure was for 10 seconds with an input of 1500 mJ/cm² energy.

The inventive printed substrates S1.1 to S1.3 as per table 3 were obtained and the rub fastness was determined according to ISO-105-D02:1993 and the wash fastness according to ISO 105-C06:1994.

TABLE 3
Fastnesses of cotton printed according to invention

| | Rub fastness | | Rub fastness |
|---|---|---|---|
| Substrate | (dry) | Wash fastness | (wet) |
| S1.1 | 3 | 3-4 | 2-3 |
| S1.2 | 3 | 3 | 2-3 |
| S1.3 | 3-4 | 4 | 2-3 |

1-19. (canceled)

20: The method of obtaining a water soluble radiation curable products (A) by
mixing with or without reaction of
at least one hyperbranched polyurethane (a) with
at least one photoinitiator (b)
or by synthesis of
at least one hyperbranched polyurethane (a)
in the presence of at least one photoinitiator (b)
said photoinitiators (b) being selected from α-cleave and hydrogen abstracting photoinitiators,
to produce aqueous inks for the ink jet process.

21: The method according to claim 20 wherein at least one hyperbranched polyurethane (a) is a hyperbranched polyurethane (a) having at least one NCO group per molecule.

22: The method according to claim 20, wherein water soluble radiation curable products (A) are water soluble radiation curable products (A) having at least one COOH group per molecule.

23: Aqueous inks for the ink jet process having a dynamic viscosity in the range from 2 to 80 mPa·s, measured at 23° C., comprising
mixing with or without reaction of
at least one hyperbranched polyurethane (a) with
at least one photoinitiator (b)
or by synthesis of
at least one hyperbranched polyurethane (a)
in the presence of at least one photoinitiator (b),
said photoinitiators (b) being selected from α-cleave and hydrogen abstracting photoinitiators,
(B) at least one pigment.

24: The inks according to claim 23 wherein at least one hyperbranched polyurethane (a) is a hyperbranched polyurethane (a) having at least one NCO group per molecule.

25: The inks according to claim 23 wherein water soluble radiation curable products (A) are water soluble radiation curable products (A) having at least one COOH group per molecule.

26: The inks according to claim 25 wherein water soluble radiation curable products (A) having at least one COOH group per molecule are prepared by adding β-alanine during the preparation of water soluble radiation curable products (A).

27: The inks according to claim 23 that comprise
(C) at least one photopolymerizable compound selected from compounds having at least two ethylenic double bonds per molecule and compounds of the general formula I 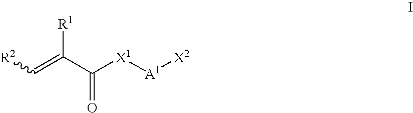
where
R¹ and R² are the same or different and are each independently selected from hydrogen and C₁-C₁₀-alkyl,
X¹ is selected from oxygen and N—R³,
A¹ is selected from C₁-C₂₀-alkylene which is unsubstituted or substituted by one or more of C₁-C₄-alkyl, phenyl or O—C₁-C₄-alkyl and in which one or more nonadjacent CH₂ groups may be replaced by oxygen;
X² is selected from hydroxyl and NH—R³,
R³ is in each occurrence the same or different and selected from hydrogen, C₁-C₁₀-alkyl and phenyl.

28: The inks according to claim 27 wherein (C) at least one photopolymerizable compound is selected from compounds of the general formula II 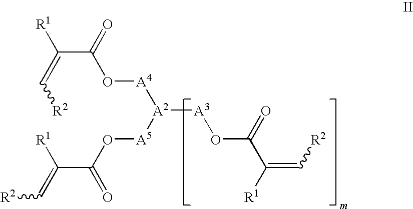
where
R¹ and R² are the same or different and are each independently selected from hydrogen and C₁-C₁₀-alkyl,
m is an integer from 0 to 2,
A² is CH₂ or —CH₂—CH₂— or R⁵—CH or para-C₆H₄ when m is =0, CH, C—OH, C—O—C(O)—CH═CH₂, C—O—CO—C(CH₃)═CH₂, R⁵—C or 1,3,5-C₆H₃ when m is =1,
and carbon when m is =2;
R⁵ is selected from C₁-C₄-alkyl and phenyl,
A³, A⁴ and A⁵ are the same or different and are each selected from
C₁-C₂₀-alkylene, cis- or trans-C₄-C₁₀-cycloalkylene, C₁-C₂₀-alkylene, in each of which from one up to seven carbon atoms which are each nonadjacent may be replaced by oxygen,
C₁-C₂₀-alkylene which is substituted by up to 4 hydroxyl groups and in which from one up to seven carbon atoms which are each nonadjacent may be replaced by oxygen, C₆-C₁₄-arylene.

29: The inks according to claim 23 that comprise
from 1% to 20% by weight of (A),
from 0.01% to 20% by weight of (B)
from 0% to 10% by weight of (C),
all based on the total weight of the ink.

30: The inks according to claim 23 that comprise
from 1.5% to 15% by weight of (A),
from 1% to 10% by weight of (B)
from 0.1% to 9% by weight of (C),
all based on the total weight of the ink.

31: A process for producing inks according to claim 23, which comprises mixing (A), (B), water and if appropriate (C) with one another.

32: A process for printing sheetlike substrates using inks according to claim 23.

33: The process for printing sheetlike substrates using inks according to claim 23 and subsequent treating with actinic radiation.

34: Water soluble radiation curable products (A) obtainable by
mixing and reaction of
at least one hyperbranched polyurethane (a) with
from 0.001% to 10% by weight, based on (a), of at least one photoinitiator (b),
or by synthesis of
at least one hyperbranched polyurethane (a)
in the presence of from 0.001% to 10% by weight, based on (a), of at least one photoinitiator (b),
said photoinitiators (b) being selected from α-cleave and hydrogen abstracting photoinitiators.

35: The water soluble radiation curable products according to claim 34 wherein at least one hyperbranched polyurethane (a) is a hyperbranched polyurethane (a) having at least one NCO group per molecule.

36: The water soluble radiation curable products according to claim 34 that have at least one COOH group per molecule.

37: The water soluble radiation curable products according to claim 34 that further comprise (C) at least one photopolymerizable compound selected from compounds having at least two ethylenic double bonds per molecule and compounds of the general formula I 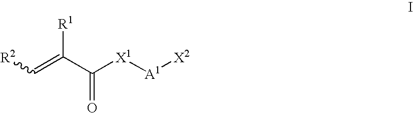
where
R¹ and R² are the same or different and are each independently selected from hydrogen and C₁-C₁₀-alkyl,
X¹ is selected from oxygen and N—R³,
A¹ is selected from C₁-C₂₀-alkylene which is unsubstituted or substituted by one or more of C₁-C₄-alkyl, phenyl or O—C₁-C₄-alkyl and in which one or more nonadjacent CH₂ groups may be replaced by oxygen;
X² is selected from hydroxyl and NH—R³,
R³ is in each occurrence the same or different and selected from hydrogen, C₁-C₁₀-alkyl and phenyl.

38: The water soluble radiation curable products according to claim 34 wherein (C) at least one photopolymerizable compound is selected from compounds of the general formula II 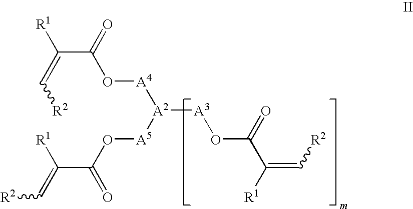
where
R¹ and R² are the same or different and are each independently selected from hydrogen and C₁-C₁₀-alkyl,
m is an integer from 0 to 2,
A² is CH₂ or —CH₂—CH₂— or R⁵—CH or para-C₆H₄ when m is =0, CH, C—OH, C—O—C(O)—CH═CH₂, C—O—CO—C(CH₃)═CH₂, R⁵—C or 1,3,5-C₆H₃ when m is =1,
and carbon when m is =2;
R⁵ is selected from C₁-C₄-alkyl and phenyl,
A³, A⁴ and A⁵ are the same or different and are each selected from
C₁-C₂₀-alkylene, cis- or trans-C₄-C₁₀-cycloalkylene, C₁-C₂₀-alkylene, in each of which from one up to seven carbon atoms which are each nonadjacent may be replaced by oxygen,
C₁-C₂₀-alkylene which is substituted by up to 4 hydroxyl groups and in which from one up to seven carbon atoms which are each nonadjacent may be replaced by oxygen, C₆-C₁₄-arylene.
